(19) United States
(12) Patent Application Publication
(10) Pub. No.: US 2010/0225851 A1
(43) Pub. Date: Sep. 9, 2010

(54) LIQUID CRYSTAL DISPLAY DEVICE

(75) Inventor: Chao-Jen Chang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/544,229

(22) Filed: Aug. 20, 2009

(30) Foreign Application Priority Data
Mar. 6, 2009 (TW) 98203478

(51) Int. Cl. G02F 1/13357

(52) U.S. Cl. 349/71

(57) ABSTRACT

A transflective mode liquid crystal display (LCD) combines advantages of a transmissive mode display and a reflective mode display, and has high display quality under different indoor and outdoor ambient lights. But the transflective mode LCD brings problems of non-uniform brightness, poor contrast ratio, and non-uniform color between a transmissive area and a reflective area if light rays passing through the transmissive area and the reflective area in the transflective mode LCD are improperly controlled. Thus, an overall transmissive and reflective mode LCD is provided, which not only has all the advantages of the transmissive mode display and the reflective mode display, but also improves a brightness of a panel, and solves the problems of non-uniform brightness, poor contrast ratio, and non-uniform color.

### CROSS-REFERENCE TO RELATED APPLICATION

This application claims the priority benefit of Taiwan application serial no. 98203478, filed on Mar. 6, 2009. The entirety of the above-mentioned patent application is hereby incorporated by reference herein and made a part of specification.

### BACKGROUND OF THE INVENTION

1. Field of the Invention

The present invention generally relates to a liquid crystal display (LCD) device, in particular, to an LCD device capable of improving a brightness of a liquid crystal display panel, and solving problems of non-uniform brightness, poor contrast ratio, and non-uniform color.

2. Description of Related Art

When a transmissive mode LCD is used under strong outdoor sunlights, an intensity of an ambient light is usually much higher than that of a backlight source, such that human eyes cannot figure out the image information clearly. Although a reflective mode LCD can overcome the above problem, the brightness of the reflective mode LCD is not sufficient when the reflective mode LCD is used at indoor dark positions. Therefore, in order to enable the LCD to achieve a preferred display quality under different ambient lights, a semi-transmissive and semi-reflective (hereafter referred to as transflective) display mode has been developed in a portable LCD.

In a transflective mode LCD, the disadvantages of the transmissive mode LCDs and the reflective mode LCDs can be improved, such that the display quality is excellent under different indoor and outdoor ambient lights.

FIG. 1 is a schematic view of a conventional transflective mode LCD. Referring to FIG. 1, a pixel 10 of the transflective mode LCD includes an LCD panel 101 and a light source 103 disposed under the LCD panel 101. The LCD panel 101 includes a transmissive area 130 and a reflective area 140. A reflecting plate 1011 is disposed within the LCD panel 101, so as to form the reflective area 140.

Light source light 110 emitted from the light source 103 exits from the transmissive area 130. Ambient light 120 is reflected by the reflecting plate 1011 of the reflective area 140. The light source light 110 and the ambient light 120 exit to a display surface, and are received by the human eyes. A light path of the reflective area 140 is different from that of the transmissive area 130 in the transflective mode LCD, and the light path of the reflective area 140 is approximately twice of that of the transmissive area 130, and passes through the LC layer and the color filter layer back and forth for twice, such that the brightness and the chromaticity of the two areas are different. Usually, as for the reflective area 140, a light efficiency is increased by sacrificing a color saturation, so as to achieve a higher light transmission rate. As for the transmissive area 130, the times for the light to pass through the color filter layer are only half of that of the reflective area 140, such that the color saturation thereof is rather poor. Therefore, it has become a key problem to be overcome in the transflective mode LCD how to adjust the brightness, contrast ratio, and color saturation of the reflective area 140 and the transmissive area 130 into a consistent status.

### SUMMARY OF THE INVENTION

Accordingly, the present invention is directed to a liquid crystal display (LCD) device, which is capable of improving a brightness of a liquid crystal display panel, and solving problems of non-uniform brightness, poor contrast ratio, and non-uniform color.

As embodied and broadly described herein, the present invention provides an LCD device. A structure of the LCD device according to the present invention is a display having overall transmissive and reflective characteristics, which is different from a transflective mode LCD having a reflective area as one half and a transmissive area as the other half in one pixel.

The present invention provides an LCD device, which includes an ultraviolet (UV) lamp, a low-wavelength filter arranged above the UV lamp, a phosphor layer arranged above the low-wavelength filter, a high-wavelength filter arranged above the phosphor layer, and an LCD panel arranged above the high-wavelength filter.

In the LCD device, the high-wavelength filter is a filter capable of being transmitted by a visible light (380 nm-780 nm) and reflecting a UV light (below 380 nm).

In the LCD device, the low-wavelength filter is a filter capable of being transmitted by a UV light (below 380 nm) and reflecting a visible light (380 nm-780 nm).

In the LCD device, the phosphor layer includes a substrate, and a phosphor, coated on the substrate.

In the LCD device, the substrate is a transparent material.

In the LCD device, a heat resistant temperature of the substrate is 200° C.-500° C.

In the LCD device, the substrate includes a glass material.

In the LCD device, the substrate includes a recess portion.

In the LCD device, at least one supporting body is further disposed at the recess portion.

In the LCD device, the substrate and the supporting body are integrally formed.

As for a principle of the LCD device of the present invention, the wavelength ranges of the high-wavelength filter and the low-wavelength filter for the UV light (0 nm-380 nm) and the visible light (380 nm-780 nm) are different, such that a LCD device having both the transmissive characteristics and the reflective characteristics can be fabricated.

The operating mechanisms for the structure of the present invention may be classified into two types, namely, a UV light source and an ambient light. When a current is output to the UV lamp, the UV light is generated, and then the UV light passes through the low-wavelength filter and excites the phosphor layer, so as to generate the visible light. The visible light then passes through the high-wavelength filter to reach the display surface, and is received by the human eyes, and the residual UV light is reflected by the high-wavelength filter and continues to excite the phosphor layer to generate the visible light. Meanwhile, when the external ambient light enters the panel, the external ambient light is reflected to the display surface by the low-wavelength filter, and is received by the human eyes.

The LCD device has the overall transmissive and reflective characteristics, such that the brightness, contrast ratio, and color saturation of the whole panel are consistent, without the common problems of the transflective mode LCD. The structure of the LCD device has the characteristics of both the transmissive mode display and the reflective mode display, such that the optical characteristics thereof are better than that of a common transflective thin film transistor (TFT) LCD.

In order to make the aforementioned and other objectives, features, and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a transflective mode LCD device in the prior art.

FIG. 2 is a schematic view of an LCD according to an embodiment of the present invention.

FIG. 3 is a schematic view of an operating mechanism for a UV light source of an LCD according to an embodiment of the present invention.

FIG. 4 is a schematic view of an operating mechanism for an ambient light of an LCD according to an embodiment of the present invention.

FIG. 5 is a schematic view of a substrate of a phosphor layer for an LCD according to an embodiment of the present invention.

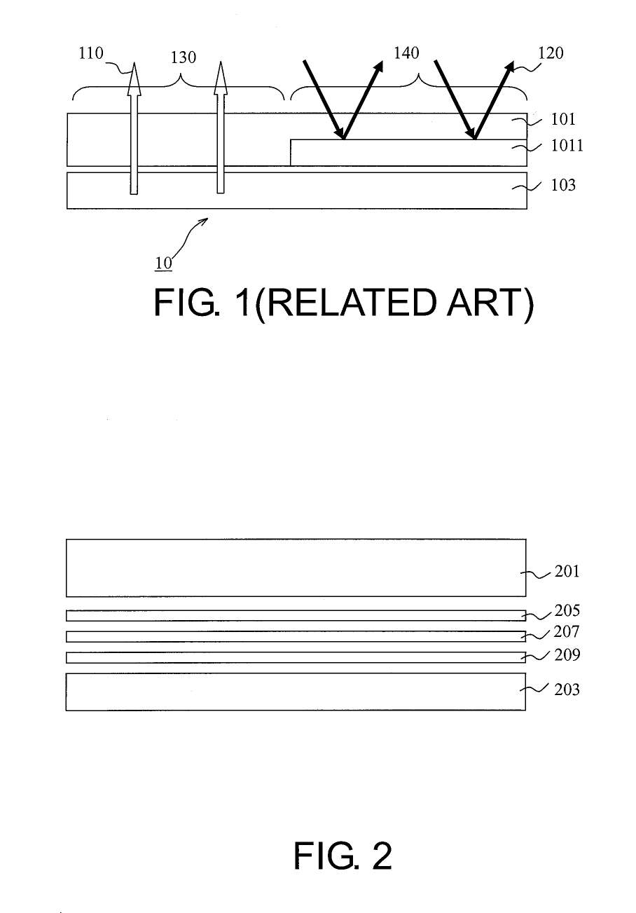

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 2 is a schematic view of an LCD device according to an embodiment of the present invention. Referring to FIG. 2, an LCD device according to an embodiment of the present invention includes a UV lamp 203, a low-wavelength filter 209 arranged above the UV lamp 203, a phosphor layer 207 arranged above the low-wavelength filter 209, a high-wavelength filter 205 arranged above the phosphor layer 207, and an LCD panel 201 arranged above the high-wavelength filter 205.

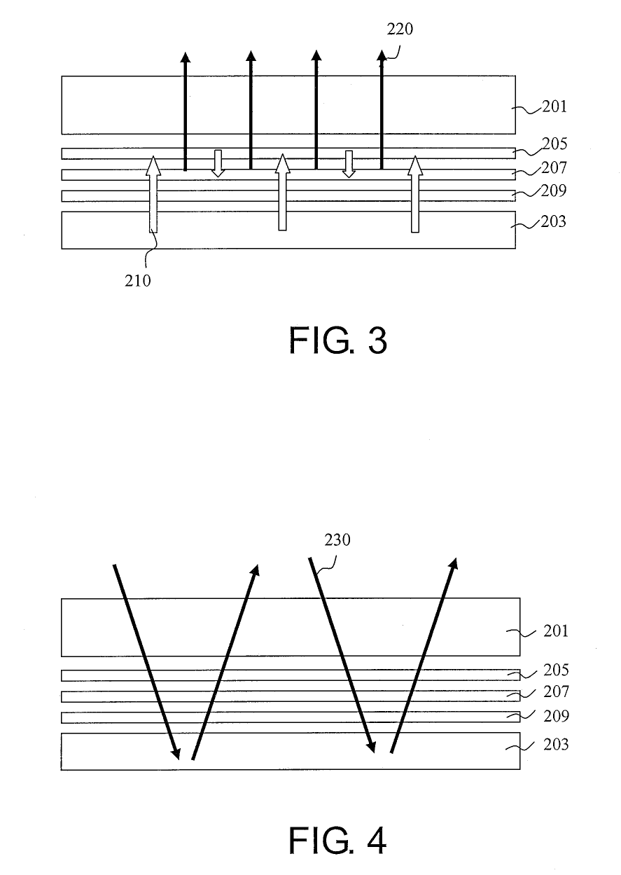

In this embodiment, the operating mechanisms for a structure of the LCD device according to the present invention may be classified into two types, namely, a UV light source and an ambient light. Referring to FIG. 3, when a current is output to the UV lamp 203, a UV light 210 is generated, and then the UV light 210 passes through the low-wavelength filter 209 and excites the phosphor layer 207, so as to generate a visible light 220. The visible light 220 then passes through the high-wavelength filter 205 to reach a display surface, that is, the visible light 220 is received by human eyes, and the residual UV light 210 is reflected by the high-wavelength filter 205 and continues to excite the phosphor layer 207 to generate the visible light 220. Referring to FIG. 4, when an external ambient light (visible light) 230 enters the panel 201, the external ambient light 230 is reflected to the display surface by the low-wavelength filter 209, and is received by the human eyes.

In this embodiment, if a UV light source with a wavelength of 254 nm is used, a white light phosphor material (mixed by blue, green, and red phosphors) with the following formula may be used together,; that is, blue phosphor: (Ba,Sr)MgAl₁₀O₁₇:EuMn, green phosphor: LaPO₄:Ce,Tb, and red phosphor: Y₂O₃:Eu.

In this embodiment, if a UV light source with a wavelength of 147 nm is used, a white light phosphor material (mixed by blue, green, and red phosphors) with the following formula may be used together, that is, blue phosphor: BaMgAl₁₀O₁₇:Eu, green phosphor: Zn₂SiO₄:Mn, and red phosphor: (Y,Gd)BO₃:Eu.

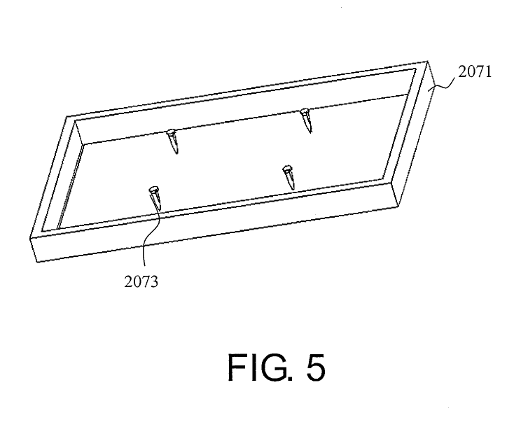

Referring to FIGS. 2 and 5, a method for fabricating an LCD device may be divided into two types. In an embodiment, if the low-wavelength filter 209 and the high-wavelength filter 205 are both thin films, a glass is taken as a substrate 2071. The substrate 2071 has a recess portion, at least one supporting body 2073 is further disposed at the recess portion, and a phosphor is injected into the recess portion, so as to form a phosphor layer 207. Through a drying process (80° C.-120° C.) and a sintering process (300° C.-550° C.), a frame glue is coated on a periphery of the glass substrate 2071. Then, after being dried, the glass substrate 2071 and a second glass substrate are synchronously processed through a vacuum pumping and then are assembled. Then, the low-wavelength filter 209 and the high-wavelength filter 205 are adhered to the upper and lower glass substrates. Finally, an LCD panel 201 is arranged above the assembly, and a UV lamp 203 is arranged under the assembly. In another embodiment, the low-wavelength filter 209 and the high-wavelength filter 205 may be glass products. In this case, the low-wavelength filter 209 serves as the substrate 2071, the substrate 2071 has a recess portion, at least one supporting body 2073 is further disposed at the recess portion, and a phosphor is injected into the recess portion, so as to form a phosphor layer 207. Through a drying process (80° C.-120° C.) and a sintering process (300° C.-550° C.), a frame glue is coated on a periphery of the substrate 2071. Then, after being dried, the substrate 2071 and the high-wavelength filter 205 are synchronously processed through a vacuum pumping and then are assembled. Finally, an LCD panel 201 is arranged above the assembly, and a UV lamp 203 is arranged under the assembly.

Referring to FIG. 5, in the methods for fabricating the LCD device of the two embodiments, the substrate 2071 is made of a transparent material, which includes a glass material, and a heat resistant temperature thereof is in a range of 200° C.-500° C.

Referring to FIG. 5, in the methods for fabricating the LCD device of the two embodiments, the substrate 2071 and the supporting body 2073 are integrally formed, in which the supporting body 2073 is used to support the high-wavelength filter 205, so as to prevent the high-wavelength filter 205 from being recess to result in Mura.

To sum up, in the present invention, by using a design and an efficacy that wavelength ranges of the high-wavelength filter and the low-wavelength filter for the UV light (0 nm-380 nm) and the visible light (380 nm-780 nm) are different, the display having the overall transmissive and reflective characteristics is fabricated, so as to solve the problems of non-uniform brightness, poor contrast ratio, and non-uniform color resulted by the transflective mode LCD.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display (LCD) device, comprising:
an ultraviolet (UV) lamp;
a low-wavelength filter, arranged above the UV lamp;
a phosphor layer, arranged above the low-wavelength filter;
a high-wavelength filter, arranged above the phosphor layer; and
a liquid crystal display (LCD) panel, arranged above the high-wavelength filter.

2. The LCD device according to claim 1, wherein the high-wavelength filter is a filter capable of being transmitted by a visible light (380 nm-780 nm) and reflecting a UV light (below 380 nm).

3. The LCD device according to claim 1, wherein the low-wavelength filter is a filter capable of being transmitted by a UV light (below 380 nm) and reflecting a visible light (380 nm-780 nm).

4. The LCD device according to claim 1, wherein the phosphor layer comprises:
a substrate; and
a phosphor, coated on the substrate.

5. The LCD device according to claim 4, wherein the substrate is a transparent material.

6. The LCD device according to claim 4, wherein a heat resistant temperature of the substrate is 200° C.-500° C.

7. The LCD device according to claim 4, wherein the substrate comprises a glass material.

8. The LCD device according to claim 4, wherein the substrate comprises a recess portion.

9. The LCD device according to claim 6, wherein at least one supporting body is further disposed at the recess portion.

10. The LCD device according to claim 7, wherein the substrate and the supporting body are integrally formed.
